(19) United States
(12) Patent Application Publication
(10) Pub. No.: US 2006/0045076 A1
(43) Pub. Date: Mar. 2, 2006

(54) Method and system for routing call in VoIP gateway

(76) Inventor: Pyung-Bin Lim, Suwon-si (KR)

Correspondence Address: Robert E. Bushnell, Suite 300, 1522 K Street, N.W., Washington, DC, 20005, US

(21) Appl. No.: 11/215,003

(22) Filed: Aug. 31, 2005

(30) Foreign Application Priority Data
Aug. 31, 2004 (KR) 2004-0069286

(51) Int. Cl. H04L 12/66

(52) U.S. Cl. 370/352

(57) ABSTRACT

A method and system for routing a call in a Voice over Internet Protocol (VoIP) gateway in which, when a caller tries making a VoIP call via a foreign exchange station (FXS), the VoIP gateway inserts a certain prefix into a relevant FXS port to allow a called gateway to identify a caller based on the prefix so that a foreign exchange office (FXO) port is allocated according to subscriber's priority.

### CLAIM OF PRIORITY

This application makes reference to, incorporates the same herein, and claims all benefits accruing under 35 U.S.C. §119 from an application for METHOD FOR CALL ROUTING OF VoIP GATEWAY AND SYSTEM THEREOF earlier filed in the Korean Intellectual Property Office on Aug. 31, 2004 and there duly assigned Serial No. 2004-69286.

### BACKGROUND OF THE INVENTION

1. Field of the Invention

The present invention relates to a Voice over Internet Protocol (VoIP) gateway, and more particularly, to a method and system for routing a call in a VoIP gateway in which when a caller tries making a VoIP call via an FXS (foreign exchange station), the VoIP gateway inserts a certain prefix (e.g., identifier) into a relevant FXS port to allow a called gateway to identify a caller based on the prefix, such that an FXO (foreign exchange office) port is allocated according to subscriber's priority.

2. Description of the Related Art

Presently, differentiated VoIP services are being provided depending on subscription grades which are marked differently to give priority to each subscriber.

For such differentiated services, different priority is given for use of a gateway port. A calling VoIP gateway, which interworks with an existing private branch exchange (PBX),cannot send caller information to a called gateway because the PBX adopts analog lines.

When terminal devices connected to the calling and called gateways are digital ones, it is possible to provide a differentiated service for each subscriber since caller ID is provided. However, it is not the case when the terminal devices of the respective gateways are analog ones.

In particular, since a PBX of a public switched telephone network (PSTN) type connected to the called gateway adopts an analog manner, it is impossible to be aware of the caller ID.

### SUMMARY OF THE INVENTION

It is an object of the present invention to provide a system and method for routing a call in a VoIP gateway in which a prefix (e.g., identifier) is inserted according to a port to which a telephone terminal of a subscriber subscribing to a VoIP gateway is connected, and the inserted prefix is transmitted to a next VoIP gateway so that priority information of a caller is recognized, thereby providing a differentiated service for each subscriber.

In order to achieve the above object, the present invention provides a method for routing a call in a voice over IP (VoIP) gateway, including: requesting, by at least one caller, a VoIP call using their telephone terminal; inserting, by a calling gateway, a prefix for each foreign exchange station (FXS) port in response to the VoIP call request; routing, by the calling gateway, the VoIP call containing the prefix; identifying, by a called gateway, a caller based on the prefix contained in the received VoIP call; allocating, by the called gateway, a foreign exchange office (FXO) port for each identified caller; and routing, by the called gateway, the VoIP call to a destination telephone terminal via the allocated FXO port.

The method may further include removing the prefix, which is inserted by the calling gateway, when a relevant VoIP call is set by the called gateway to be routed via the relevant FXO port.

Allocating the FXO port for each caller may include allocating at least one FXO port for each subscription grade of callers according to a prescribed rule or policy. The method may include allocating the FXO port for each priority, the priority being given for each subscription grade of callers.

Inserting the prefix for each FXS includes including the prefix into a destination telephone number of a VoIP call incoming via each FXS port.

The method includes identifying the caller based on the prefix contained in the destination telephone number and routing the VoIP call to the FXO port allocated according to a subscription grade for each subscriber.

The present invention provides a system for routing a call in a VoIP gateway,including: a calling gateway for routing a VoIP call from users who subscribe to a VoIP service to a relevant destination, and including a certain prefix (e.g., identifier) into a destination telephone number according to a FXS port receiving a VoIP call to transmit it to a next stage; and a called gateway for identifying a caller based on the prefix received with the destination telephone number and routing the VoIP call to an FXS port upon receipt of the VoIP call from the calling gateway, the FXS port being previously set according to a grade of the identified caller.

The calling gateway may interface a caller terminal via the FXS port and insert a prescribed prefix into a destination telephone number for each FXS port to transmit it to a next stage.

The called gateway may discover an FXO port matched to a prefix value, which is received with the destination telephone number, by referring to an FXO port allocation table and route the VoIP call to a relevant FXO port.

The called gateway may remove the prefix, which is inserted by the calling gateway, when a relevant VoIP call is set by the called gateway to be routed via the relevant FXO port.

In the FXO port allocation table, at least one FXO port may be allocated for each grade of callers by a prescribed rule or policy. The FXO port may be allocated for each priority, the priority being given to each caller according to a subscriber line lease

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a schematic diagram of a VoIP call routing system;

FIG. 2 is a schematic diagram illustrating a method of inserting a prefix, i.e., an identifier, of a calling gateway according to an embodiment of the present invention;

FIG. 3 is a schematic diagram illustrating call routing system and process of a VoIP gateway according to an embodiment of the present invention;

FIG. 4a illustrates a process of inserting a prefix ina calling gateway according to an embodiment of the present invention;

FIG. 4b illustrates a process of selecting an FXO port using a prefix in a called gateway according to an embodiment of the present invention; and

FIG. 4c illustrates a process of connecting a VoIP call to a destination telephone through an FXO port according to an embodiment of the present invention.

### DETAILED DESCRIPTION OF THE PREFERRED EMBODIMENTS

Hereinafter, a prior art will be described with reference to the drawings.

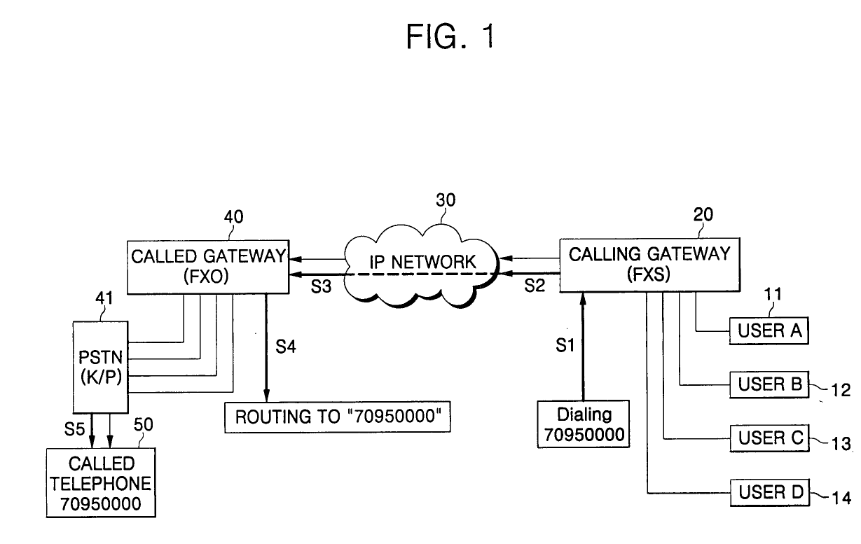

FIG. 1 is a schematic view illustrating the configuration of a VoIP call routing system.

Foreign exchange station (FXS)and foreign exchange office (FXO) interfaces, which are major components of the present invention, will be described before the configuration of the VoIP call routing system is described.

The FXS interface performs the same function as a PBX and is used for connection of a telephone, a facsimile, or a PBX trunk.

The FXS has the following major functions:
emulating a central office;
generating a ringing signal;
detecting off-hook and on-hook; and
receiving dialing information.

The FXO interface serves as a telephone and is used for connection to a local PBX's extension line or a PSTN line.

The FXO has the following major functions:
emulating a telephone;
detecting a ringing signal;
detecting off-hook and on-hook; and
transmitting dialing information.

Referring to FIG. 1, when a subscriber registered with a calling gateway 20 presses digits “70950000” to originate a call (S1), the calling gateway 20 makes a VoIP call with respect to “7095000” over an IP network 30 as a destination (S2 and S3).

The FXO must allocate a port so that a called gateway 40 routes an incoming call to a PSTN (K/P or PBX). Since there is no determination condition to apply a subscriber line lease condition or a call routing policy, an FXO port is allocated at random (S4).

Through such operation, a caller telephone is connected to a called telephone 50 corresponding to the number “70950000” (S5).

The detailed discussion on the called gateway 40 is given. Routing an incoming VoIP call to the PSTN requires allocation of the FXO port interfaced with the PBX.

However, a random FXO port can be allocated, which is not a specific FXO port, since there is no determination condition to apply a call routing policy or a subscriber line lease condition with respect to the incoming VoIP call.

This is because it is difficult for the called gateway 40 to identify a caller subscriber with only the destination number “70950000.”

Although the caller ID allows identifying the caller, it is not easily done in view of characteristics of the FXS port since the calling FXS employs analog lines, not digital lines.

Thus, it is required to allocate the FXO port at random due to difficulty in identifying the subscriber.

A conventional problem will be discussed under assumption that priority of line lease for each subscriber is set as in Table 1 below.

TABLE 1

| Subscriber | FXO port used | Priority |
|---|---|---|
| User A | 1. Port No. 1 | 1 |
| | 2. Port No. 2, 3 or 4 when port No. 1 is busy | |
| User B | 1. Port No. 2 | 2 |
| | 2. Port No. 3 or 4 when port No. 2 is busy | |
| User C | 1. Port No. 3 | 3 |
| User D | 1. Port No. 4 | 4 |

Even though a user or a subscriber A 11 having the highest priority is allocated a first FXO port as in Table 1, there is a possibility that other subscribers (users B 12, C 13, D 14, etc.) are using the first port. In this case, since the other users may occupy the FXO port of the subscriber A 11, the probability that an incoming call as well as an originating call fails is very high.

As a result, it is not assured that a high-quality service is provided to the subscriber A 11, who should be allocated a port more preferentially than other users.

This is because caller information is not provided to the called gateway, which makes it impossible to recognize caller's priority.

It is reasonable that a call for the subscriber (user C 13 or D 14) with a low priority is limited when a relevant FXO port is busy. However, in a conventional manner, when the subscriber with the low priority first requests a call and occupies a certain FXO port, a subscriber with a higher priority cannot be allocated a relevant port even when requesting a call. Accordingly, it is not assured that the subscriber receives a high quality service even though he requests the high quality service.

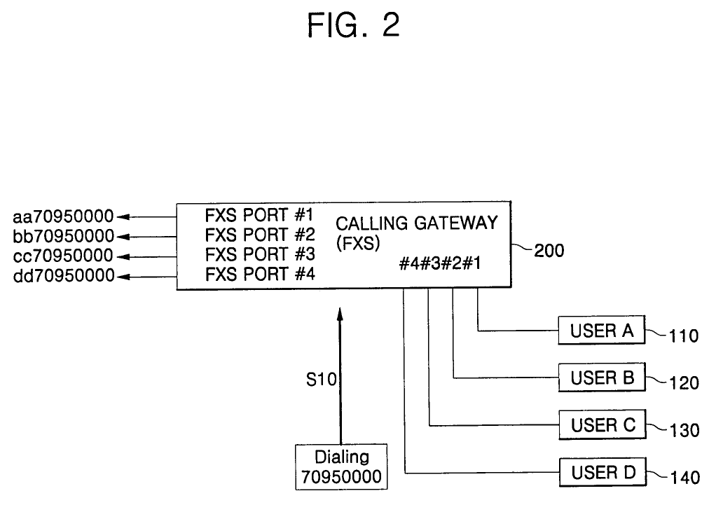

FIG. 2 is a schematic view illustrating a method of inserting a prefix, i.e., an identifier of a calling gateway, to implement the present invention.

Referring to FIG. 2, when users A, B, C or D (110, 120, 130 or 140) select a destination number “70950000” to request a call (S10), a calling gateway 200 inserts a prefix (e.g., aa, bb, cc or dd) into the VoIP call by, for example, attaching the prefix to the destination number according to a foreign exchange station (FXS) port number and routes the call to the next node.

That is, the calling gateway 200 inserts a distinguishable prefix for each port in a manner of inserting the prefix aa before the destination number of a call incoming from a first FXS port and the prefix bb before the destination number of a call incoming from a second FXS port. Thus, for the call incoming from the user A 110, the whole destination telephone number becomes “aa70950000” including the prefix.

An overall path of a VoIP call and a call routing system will be discussed below.

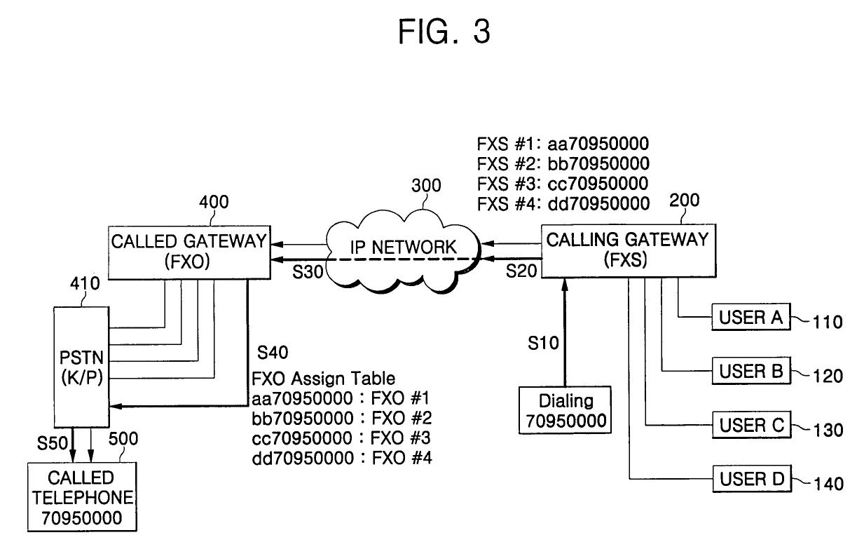

FIG. 3 is a schematic view illustrating a call routing system and process of a VoIP gateway according to an embodiment of the present invention.

Referring to FIG. 3, when at least one of the subscribers, i.e., users A, B, C or D (110, 120, 130 or 140) registered with the calling gateway 200, presses digits “70950000” to originate a call (S10), the calling gateway 200 inserts a prefix before the telephone number depending on an FXS port for each subscriber.

Here, the prefix may be inserted before the telephone number depending on the intention of a network operator, or may be inserted into a field other than the telephone number. A more convenient method may be selected in view of management.

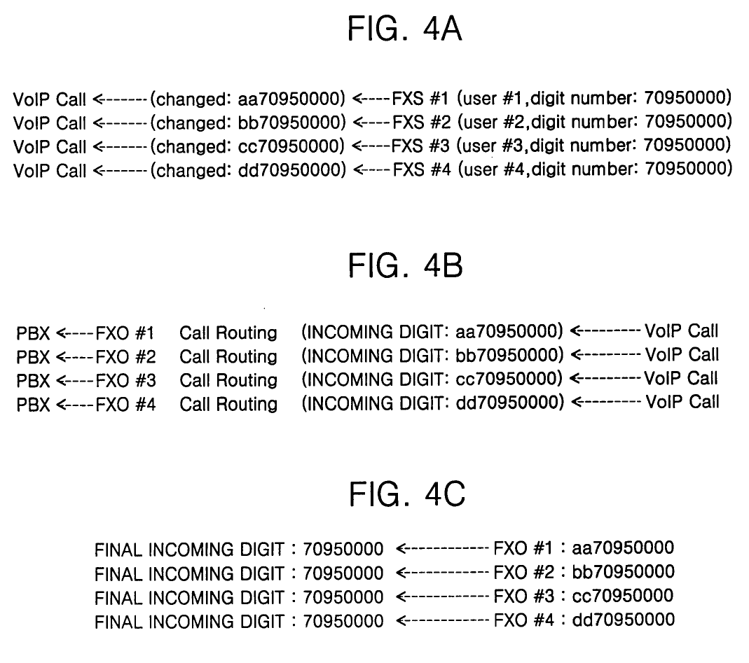

The prefix method of inserting the prefix before the telephone number will be discussed below with reference to both FIGS. 3 and 4a.

FIG. 4a illustrates inserting a prefix in a calling gateway according to the present invention.

As shown in FIGS. 3 and 4a, the calling gateway 200 inserts a prefix aa before a telephone number in the case of a call incoming via a first FXS port (user A 110), or a prefix bb before the telephone number in the case of a call incoming via a second FXS port (user B 120).

The VoIP call is transmitted (S20) to a called gateway 400 over an IP network 300 with the prefix being inserted before the telephone number (S30).

The called gateway 400 must route the incoming call to a PSTN 410 which is an analog line, requiring a task allocating an FXO port, prior to the VoIP call being transmitted (S 50) to the called telephone 500.

By referring to a VoIP inbound routing table of Table 2, the called gateway 400 may allocate an FXO port based on information in a PSTN path field of an entry, which is matched to a prefix inserted before the destination telephone number (S40).

TABLE 2

PSTN Path

| No. | Access Code | . . . | Slot | Port |
|---|---|---|---|---|
| 0 | aa | . . . | 1 | 1 |
| 1 | bb | . . . | 1 | 2 |
| 2 | cc | . . . | 1 | 3 |
| 3 | dd | . . . | 1 | 4 |
| . | . | . . . | . | . |
| . | . | . . . | . | . |
| . | . | . . . | . | . |

Here, the allocation of the FXO port is determined by a previously set rule or policy.

FIG. 4b illustrates setting an FXO port using a prefix in a called gateway according to the present invention.

Referring to FIG. 4b, upon receipt of the incoming VoIP call, the called gateway 400 allocates the FXO port based on the prefix received with the telephone number and then routes the VoIP call to the PSTN 410 (S40).

After allocating the FXO port, the called gateway 400 removes the prefix from the whole telephone number and transmits the VoIP call to the PSTN 410, as shown in FIG. 4c.

FIG. 4c illustrates a process of connecting a VoIP call to a destination telephone number via an FXO port according to the present invention. It shows that, after an FXO port is determined for a destination telephone number having a prefix inserted, only the destination telephone number is transmitted with the prefix being removed.

The PSTN 410 then routes the VoIP call incoming via the FXO port to a destination telephone 500 (S50).

The path to route the overall VoIP call is summarized as follows. The calling gateway inserts the prefix depending on the FXS port and the called gateway transmits the VoIP call via the FXO port allocated according to a previously set policy, thereby providing a stabilized service.

Currently, a different priority to use a port in the VoIP service is given according to a subscription grade for each subscriber. However, since there was no method capable of identifying the caller at the called VoIP gateway which interworks with an existing PBX, it was difficult to give a priority according to a subscription grade for each subscriber.

The present invention, however, assigns the prefix to the telephone number in a manner of inserting a prefix and the called gateway can identify the caller based on the prefix without using separate equipment. Thus, it is possible to provide a differentiated VoIP call service according to a subscription grade for each subscriber, which makes it possible for the subscriber to receive a more stabilized service.

Further, a service provider is capable of providing a differentiated service to subscribers according to the subscriber grade, thereby facilitating line management.

Although preferred embodiments of the present invention have been described, it will be understood by those skilled in the art that the present invention should not be limited to the described preferred embodiments. Rather, various changes and modifications can be made within the spirit and scope of the present invention, as defined by the following claims.

What is claimed is:

1. A method for routing a call in a Voice over Internet Protocol (VoIP) gateway, comprising steps of:
requesting a Voice over Internet Protocol call using a telephone terminal, by at least one caller;
attaching, by a calling gateway, a prefix for said input port to said telephone number in response to the Voice over Internet Protocol call request;
routing, by the calling gateway, the Voice over Internet Protocol call containing the prefix and telephone number;
identifying, by a called gateway, said caller based on the prefix contained in the received Voice over Internet Protocol call;
allocating, by the called gateway, an output port associated with identified caller; and
routing, by the called gateway, the Voice over Internet Protocol call to a destination telephone terminal via the allocated output port.

2. A method for routing Voice over Internet Protocol calls from a plurality of calling terminals, comprising steps of:
requesting, in response to a telephone number dialed by at least one of said calling terminals, a Voice over Internet Protocol call;
inserting a prefix, associated with a foreign exchange station port connected to calling terminal dialing said telephone number, into the requested Voice over Internet Protocol call;
routing the Voice over Internet Protocol call containing the prefix over a network;
identifying a user of said calling terminal based on the prefix contained in the Voice over Internet Protocol call routed over said network;
allocating a foreign exchange office port based on the identification of said user; and
routing the Voice over Internet Protocol call to a destination telephone terminal via the allocated foreign exchange office port.

3. The method of claim 2, further comprising a step of removing the prefix from the Voice over Internet Protocol call after allocating the foreign exchange office port.

4. The method of claim 2, wherein said foreign exchange office port is allocated by a called Voice over Internet Protocol gateway based on a subscription grade of the identified user according to a prescribed policy.

5. The method of claim 4, wherein the subscription grade of each user has a predetermined priority.

6. The method of claim 2, wherein the step of inserting the prefix comprises attaching the prefix, by a calling Voice over Internet Protocol gateway, to the dialed telephone number.

7. The method of claim 6, further comprising a step of identifying the user based on the prefix contained in the destination telephone number and routing the Voice over Internet Protocol call to the foreign exchange office port allocated according to a subscription grade for said user.

8. A system for routing a Voice over Internet Protocol call over a network, comprising:
a calling gateway for routing a Voice over Internet Protocol call from users, who subscribe to a Voice over Internet Protocol service, to a relevant destination according to a dialed destination telephone number;
said calling gateway attaching a prefix to said destination telephone number according to an input port connected to a calling terminal from which said destination telephone number is dialed;
said calling gateway transmitting said Voice over Internet Protocol call including the prefix over the network; and
a called gateway connected to said network and receiving said Voice over Internet Protocol call, said called gateway identifying a user based on the prefix received with Voice over Internet Protocol call;
said called gateway allocating an output port based on the identification of said user, said Voice over Internet Protocol call being routed via said output port to a destination telephone terminal corresponding to said dialed telephone number.

9. The system of claim 8, further comprising a public switched telephone network connected between said called gateway and said destination telephone terminal.

10. The system of claim 8, wherein the input port comprises a foreign exchange station port.

11. The system of claim 8, wherein the output port comprises a foreign exchange office port.

12. The system of claim 9, wherein the called gateway transmits the destination telephone number to said public switched telephone network after removing the prefix from said destination telephone number.

13. The system of claim 11, said called gateway includes a routing table associating prefixes to corresponding foreign exchange office ports.

14. The system of claim 13, wherein priority is assigned to each user according to a subscriber line lease policy, and the foreign exchange office ports are allocated according to each priority.
